(19) United States
(12) Patent Application Publication
(10) Pub. No.: US 2023/0394599 A1
(43) Pub. Date: Dec. 7, 2023

(54) BLOCKCHAIN-BASED CARBON NEUTRAL TRANSACTION PROCESSING METHOD AND SYSTEM FOR THE SAME

(71) Applicant: Chun-Jung LIN, Kaohsiung City (TW)

(72) Inventor: Chun-Jung LIN, Kaohsiung City (TW)

(21) Appl. No.: 17/831,420

(22) Filed: Jun. 2, 2022

(51) Int. Cl. G06Q 50/06

(52) U.S. Cl. CPC G06Q 50/06

(57) ABSTRACT

A blockchain-based carbon neutral transaction processing method includes following steps. An electricity sensor of each of a plurality of blockchain nodes of a blockchain system generates a local electricity information. After the electricity sensor generates the local electricity information, the blockchain system verifies whether the local electricity information of each of the blockchain nodes is correct. If the blockchain system verifies that the local electricity information of each of the blockchain nodes is correct, the blockchain system uploads the local electricity information of each of the blockchain nodes to a blockchain network of the blockchain system.

### BACKGROUND OF THE DISCLOSURE

### Technical Field

The present disclosure relates to a carbon neutral transaction processing method and a system for the same, and especially relates to a blockchain-based carbon neutral transaction processing method and a system for the same.

### Description of Related Art

The current trend of the whole world is environmental protection and carbon reduction. According to Bloomberg New Electricity Finance, by 2050, governments and companies will need to invest at least $92 trillion to promote the electrification of the global economy and to reduce the dependence on fossil fuels, to reduce the greenhouse gas emissions and to prevent the worst effects of climate change. The so-called net zero carbon emission is that the carbon emissions and the carbon reductions offset each other to achieve the effect of the net zero carbon emission, and 128 countries around the world have declared to achieve the net zero carbon emission by 2050. The net zero carbon emission must start from supply, use, manufacture, environment, and so on.

However, in the wave of environmental protection and carbon reduction, it is a pity that the current carbon neutral transaction processing method and the current carbon neutral transaction processing system are complex and unclear.

### SUMMARY OF THE DISCLOSURE

In order to solve the above-mentioned problems, an object of the present disclosure is to provide a blockchain-based carbon neutral transaction processing method.

In order to solve the above-mentioned problems, another object of the present disclosure is to provide a blockchain-based carbon neutral transaction processing system.

In order to achieve the object of the present disclosure mentioned above, the blockchain-based carbon neutral transaction processing method of the present disclosure includes following steps. An electricity sensor of each of a plurality of blockchain nodes of a blockchain system generates a local electricity information. After the electricity sensor generates the local electricity information, the blockchain system verifies whether the local electricity information of each of the blockchain nodes is correct. If the blockchain system verifies that the local electricity information of each of the blockchain nodes is correct, the blockchain system uploads the local electricity information of each of the blockchain nodes to a blockchain network of the blockchain system.

In order to achieve the object of the present disclosure mentioned above, the blockchain-based carbon neutral transaction processing system of the present disclosure includes a plurality of blockchain nodes and a blockchain network. The blockchain network is electrically connected to the blockchain nodes. Moreover, each of the blockchain nodes includes an electricity sensor. Moreover, the electricity sensor is configured to generate a local electricity information. After the electricity sensor generates the local electricity information, the blockchain-based carbon neutral transaction processing system is configured to verify whether the local electricity information of each of the blockchain nodes is correct. If the blockchain-based carbon neutral transaction processing system verifies that the local electricity information of each of the blockchain nodes is correct, the blockchain-based carbon neutral transaction processing system is configured to upload the local electricity information of each of the blockchain nodes to the blockchain network.

The advantage of the present disclosure is to make the carbon neutral transaction processing method and the carbon neutral transaction processing system simple and clear.

### BRIEF DESCRIPTION OF THE DRAWINGS

FIG. 1 shows a block diagram of a part of an embodiment of the blockchain-based carbon neutral transaction processing system of the present disclosure.

FIG. 2 shows a flow chart of a part of a first embodiment of the blockchain-based carbon neutral transaction processing method of the present disclosure.

FIG. 3 shows a flow chart of another part of the first embodiment of the blockchain-based carbon neutral transaction processing method of the present disclosure.

FIG. 4 shows a flow chart of a part of a second embodiment of the blockchain-based carbon neutral transaction processing method of the present disclosure.

FIG. 5 shows a flow chart of another part of the second embodiment of the blockchain-based carbon neutral transaction processing method of the present disclosure.

FIG. 6 shows a flow chart of another part of the second embodiment of the blockchain-based carbon neutral transaction processing method of the present disclosure.

FIG. 7 shows a flow chart of another part of the second embodiment of the blockchain-based carbon neutral transaction processing method of the present disclosure.

FIG. 8 shows a block diagram of another part of the embodiment of the blockchain-based carbon neutral transaction processing system of the present disclosure.

FIG. 9A and FIG. 9B show flow charts of another part of the first embodiment of the blockchain-based carbon neutral transaction processing method of the present disclosure.

### DETAILED DESCRIPTION

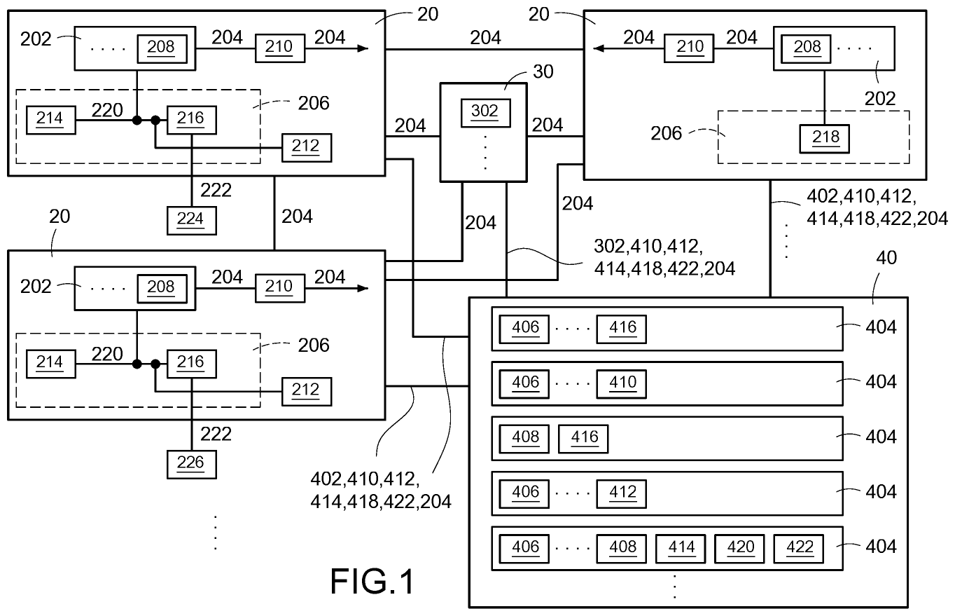

FIG. 1 shows a block diagram of a part of an embodiment of the blockchain-based carbon neutral transaction processing system 10 of the present disclosure. As shown in FIG. 1, the blockchain-based carbon neutral transaction processing system 10 of the present disclosure includes a plurality of blockchain nodes 20, a blockchain network 30 and a server 40. Each of the blockchain nodes 20 includes an electricity sensor 202 and an electricity apparatus 206. The above-mentioned components are electrically connected to each other. The blockchain-based carbon neutral transaction processing system 10 may also be referred to as a blockchain system 10.

The electricity sensor 202 is configured to sense the electricity apparatus 206 to generate a local electricity information 204. After the electricity sensor 202 generates the local electricity information 204, the electricity sensor 202 is configured to verify whether the local electricity information 204 is correct, and the server 40 is also configured to verify whether the local electricity information 204 is correct. If the electricity sensor 202 verifies that the local electricity information 204 is correct and the server 40 also verifies that the local electricity information 204 is correct, the blockchain node 20 is configured to store the local electricity information 204.

After the blockchain node 20 stores the local electricity information 204, the blockchain-based carbon neutral transaction processing system 10 is configured to verify (for example, using blockchain technology to verify) whether the local electricity information 204 of each of the blockchain nodes 20 is correct. If the blockchain-based carbon neutral transaction processing system 10 verifies that the local electricity information 204 of each of the blockchain nodes 20 is correct, the blockchain-based carbon neutral transaction processing system 10 is configured to upload the local electricity information 204 of each of the blockchain nodes 20 to the blockchain network 30.

The electricity sensor 202 is, for example but not limited to, a smart meter, and the electricity sensor 202 may also be an artificial intelligence of things (AIoT) apparatus. The electricity apparatus 206 is, for example but not limited to, a green electricity generating apparatus or an electricity consuming apparatus. The server 40 is, for example but not limited to, a cloud artificial intelligence server.

Moreover, each of the blockchain nodes 20 further includes an edge computing apparatus 210. Each of the blockchain nodes 20 on the left side of FIG. 1 further includes an electricity storage apparatus 212. The electricity apparatus 206 of each of the blockchain nodes 20 on the left side of FIG. 1 further includes a green electricity generating apparatus 214 and an inverter 216. The electricity apparatus 206 of each of the blockchain nodes 20 on the right side of FIG. 1 includes a factory production line machine 218. The above-mentioned components are electrically connected to each other. The assembly of the electricity sensor 202 and the electricity apparatus 206 is tamper-proof (namely, vandal-proof). The electricity storage apparatus 212 is, for example but not limited to, a mobile battery box or an electricity storage container.

For the blockchain nodes 20 on the left side of FIG. 1: the green electricity generating apparatus 214 is configured to generate a direct current power 220 and transmit the direct current power 220 to the inverter 216 and the electricity storage apparatus 212; the electricity storage apparatus 212 is configured to store the direct current power 220; the inverter 216 is configured to convert the direct current power 220 into an alternating current power 222 and transmit the alternating current power 222 to a household electric appliance 224 or a power grid 226; the electricity sensor 202 is configured to sense the direct current power 220 to generate the local electricity information 204 and output the local electricity information 204 through the edge computing apparatus 210. For the blockchain nodes 20 on the right side of FIG. 1: the electricity sensor 202 is configured to sense an electricity usage of the factory production line machine 218 to generate the local electricity information 204 and output the local electricity information 204 through the edge computing apparatus 210.

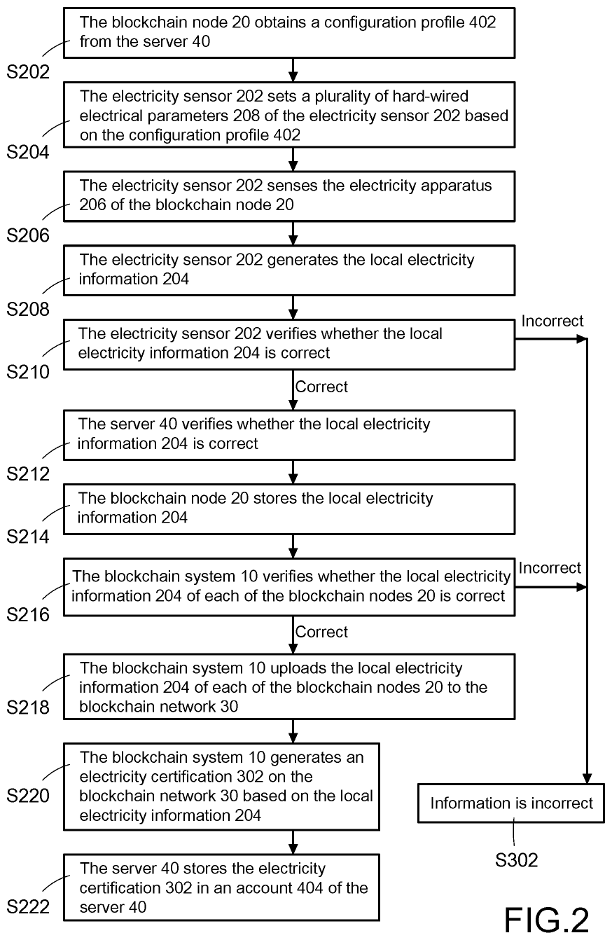

FIG. 2 shows a flow chart of a part of a first embodiment of the blockchain-based carbon neutral transaction processing method of the present disclosure; please refer to FIG. 1 at the same time. A blockchain-based carbon neutral transaction processing method of the present disclosure includes following steps:

Step S202: The blockchain node 20 obtains a configuration profile 402 from the server 40. Then, the blockchain-based carbon neutral transaction processing method goes to Step S204.

Step S204: The electricity sensor 202 sets a plurality of hard-wired electrical parameters 208 of the electricity sensor 202 based on the configuration profile 402. Then, the blockchain-based carbon neutral transaction processing method goes to Step S206.

Step S206: The electricity sensor 202 senses the electricity apparatus 206 of the blockchain node 20. Then, the blockchain-based carbon neutral transaction processing method goes to Step S208.

Step S208: The electricity sensor 202 generates the local electricity information 204. Then, the blockchain-based carbon neutral transaction processing method goes to Step S210.

Step S210: The electricity sensor 202 verifies whether the local electricity information 204 is correct. If the electricity sensor 202 verifies that the local electricity information 204 is correct, the blockchain-based carbon neutral transaction processing method goes to Step S212. If the electricity sensor 202 verifies that the local electricity information 204 is incorrect, the blockchain-based carbon neutral transaction processing method goes to Step S302.

Step S212: The server 40 verifies whether the local electricity information 204 is correct. If the server 40 verifies that the local electricity information 204 is correct, the blockchain-based carbon neutral transaction processing method goes to Step S214. If the server 40 verifies that the local electricity information 204 is incorrect, the blockchain-based carbon neutral transaction processing method goes to Step S302.

Moreover, for Step S210 and Step S212, if the green electricity generating apparatus 214 is a solar energy generating apparatus, when the local electricity information 204 measured at this time is much larger than the average value at this time of the year, it is regarded as abnormal (incorrect); for example, the solar energy should not be generated at night. Or use regional comparison monitoring; for example, the solar energy in the northern Taiwan should be smaller than the solar energy in the southern Taiwan.

Step S214: The blockchain node 20 stores the local electricity information 204. Then, the blockchain-based carbon neutral transaction processing method goes to Step S216.

Step S216: The blockchain system 10 verifies whether the local electricity information 204 of each of the blockchain nodes 20 is correct. If the blockchain system 10 verifies that the local electricity information 204 of each of the blockchain nodes 20 is correct, the blockchain-based carbon neutral transaction processing method goes to Step S218. If the blockchain system 10 verifies that the local electricity information 204 of each of the blockchain nodes 20 is incorrect, the blockchain-based carbon neutral transaction processing method goes to Step S302.

Step S218: The blockchain system 10 uploads the local electricity information 204 of each of the blockchain nodes 20 to the blockchain network 30. Then, the blockchain-based carbon neutral transaction processing method goes to Step S220.

Step S220: The blockchain system 10 generates an electricity certification 302 on the blockchain network 30 based on the local electricity information 204. Moreover, if the electricity apparatus 206 is the green electricity generating apparatus, the electricity certification 302 is a carbon credit token 406. If the electricity apparatus 206 is the electricity consuming apparatus, the electricity certification 302 is a carbon footprint 408. Then, the blockchain-based carbon neutral transaction processing method goes to Step S222.

Step S222: The server 40 stores the electricity certification 302 in an account 404 of the server 40.

Step S302: Information is incorrect.

Moreover, a first user (not shown in FIG. 1 or FIG. 2) owns the first account 404 from top to bottom in FIG. 1 and at least one of the blockchain nodes 20 in FIG. 1 (for example, the first blockchain node 20 from top to bottom on the left side of FIG. 1), and data generated by the at least one blockchain node 20 (namely, the first blockchain node 20 from top to bottom on the left side of FIG. 1) corresponds to the first account 404 from top to bottom in FIG. 1. A second user (not shown in FIG. 1 or FIG. 2) owns the second account 404 from top to bottom in FIG. 1 and at least one of the blockchain nodes 20 in FIG. 1 (for example, the second blockchain node 20 from top to bottom on the left side of FIG. 1), and data generated by the at least one blockchain node 20 (namely, the second blockchain node 20 from top to bottom on the left side of FIG. 1) corresponds to the second account 404 from top to bottom in FIG. 1. And so on, a third user (not shown in FIG. 1 or FIG. 2) owns the third account 404 from top to bottom in FIG. 1 and at least one of the blockchain nodes 20 in FIG. 1, and data generated by the at least one blockchain node 20 corresponds to the third account 404 from top to bottom in FIG. 1. A fourth user (not shown in FIG. 1 or FIG. 2) owns the fourth account 404 from top to bottom in FIG. 1 and at least one of the blockchain nodes 20 in FIG. 1, and data generated by the at least one blockchain node 20 corresponds to the fourth account 404 from top to bottom in FIG. 1. A fifth user (not shown in FIG. 1 or FIG. 2) owns the fifth account 404 from top to bottom in FIG. 1 and at least one of the blockchain nodes 20 in FIG. 1, and data generated by the at least one blockchain node 20 corresponds to the fifth account 404 from top to bottom in FIG. 1.

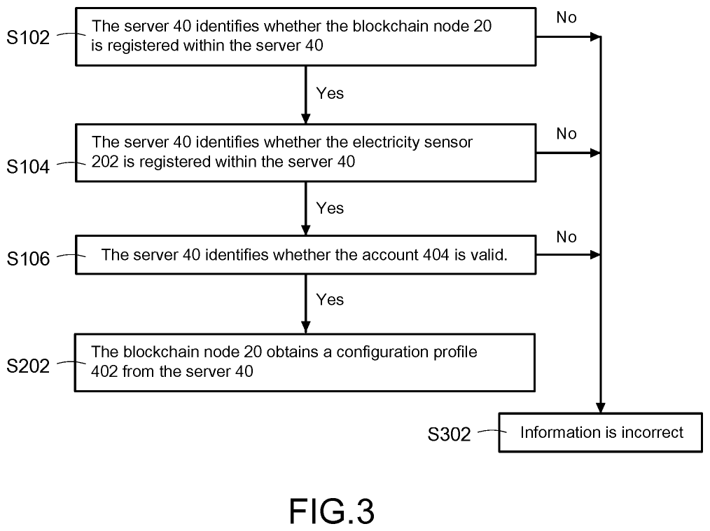

Moreover, FIG. 3 shows a flow chart of another part of the first embodiment of the blockchain-based carbon neutral transaction processing method of the present disclosure; please refer to FIG. 2 at the same time. Before Step S202 in FIG. 2, the blockchain-based carbon neutral transaction processing method of the present disclosure further includes following steps:

Step S102: The server 40 identifies whether the blockchain node 20 is registered within the server 40. If the server 40 identifies that the blockchain node 20 is registered within the server 40, the blockchain-based carbon neutral transaction processing method goes to Step S104. If the server 40 identifies that the blockchain node 20 is not registered within the server 40, the blockchain-based carbon neutral transaction processing method goes to Step S302.

Step S104: The server 40 identifies whether the electricity sensor 202 is registered within the server 40. If the server 40 identifies that the electricity sensor 202 is registered within the server 40, the blockchain-based carbon neutral transaction processing method goes to Step S106. If the server 40 identifies that the electricity sensor 202 is not registered within the server 40, the blockchain-based carbon neutral transaction processing method goes to Step S302.

Step S106: The server 40 identifies whether the account 404 is valid. If the server 40 identifies that the account 404 is valid, the blockchain-based carbon neutral transaction processing method goes to Step S202 in FIG. 2. If the server 40 identifies that the account 404 is invalid, the blockchain-based carbon neutral transaction processing method goes to Step S302 mentioned above.

In other words, after the server 40 identifies that the blockchain node 20 is registered within the server 40, and after the server 40 identifies that the electricity sensor 202 is registered within the server 40, and after the server 40 identifies that the account 404 is valid, the blockchain node obtains the configuration profile 402 from the server 40.

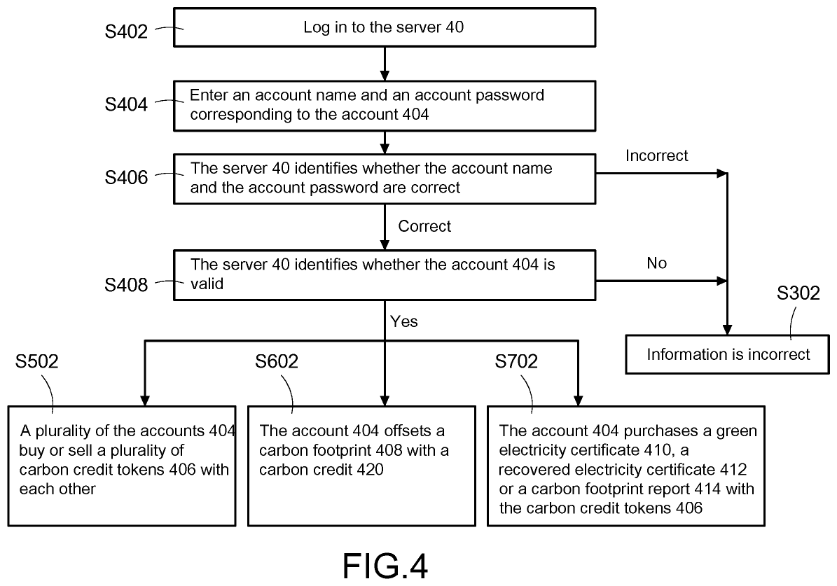

FIG. 4 shows a flow chart of a part of a second embodiment of the blockchain-based carbon neutral transaction processing method of the present disclosure; please refer to FIG. 1 and FIG. 2 at the same time. The blockchain-based carbon neutral transaction processing method of the present disclosure includes following steps:

Step S502: A plurality of the accounts 404 buy or sell a plurality of carbon credit tokens 406 with each other. Moreover, the server 40 automatically matches the accounts 404 to buy or sell the carbon credit tokens 406 with each other. For the buyer, the carbon credit tokens 406 are purchased with the actual money, such as US dollars or New Taiwan dollars, and so on. For the seller, the actual money can be obtained by selling the carbon credit tokens 406.

Step S602: The account 404 offsets a carbon footprint 408 with a carbon credit 420. Moreover, in order to achieve carbon neutral, the user can use the carbon credit tokens 406 in exchange for the carbon credit 420 to offset the carbon footprint 408. For example, the fifth user of FIG. 1 offsets the carbon footprint 408 with the carbon credit 420.

Step S702: The account 404 purchases a green electricity certificate 410, a recovered electricity certificate 412 or a carbon footprint report 414 with the carbon credit tokens 406. Moreover, in order to obtain a carbon tax compensation through the green electricity certificate 410 or the recovered electricity certificate 412, the account 404 uses the carbon credit tokens 406 to purchase the green electricity certificate 410 or the recovered electricity certificate 412 representing the carbon credit tokens 406 owned by the account 404. In order to assess company greenhouse gas emissions by the carbon footprint report 414, the account 404 uses the carbon credit tokens 406 to purchase the carbon footprint report 414 representing the carbon footprint 408 owned by the account 404. For example, the second user in FIG. 1 uses the carbon credit tokens 406 to purchase the green electricity certificate 410; the fourth user in FIG. 1 uses the carbon credit tokens 406 to purchase the recovered electricity certificate 412; the fifth user in FIG. 1 uses the carbon credit tokens 406 to purchase the carbon footprint report 414.

Moreover, before Step S502, Step S602 and Step S702, the blockchain-based carbon neutral transaction processing method further includes following steps:

Step S402: Log in to the server 40. Then, the blockchain-based carbon neutral transaction processing method goes to Step S404.

Step S404: Enter an account name and an account password corresponding to the account 404. Then, the blockchain-based carbon neutral transaction processing method goes to Step S406.

Step S406: The server 40 identifies whether the account name and the account password are correct. If the server 40 identifies that the account name and the account password are correct, the blockchain-based carbon neutral transaction processing method goes to Step S408. If the server 40 identifies that the account name and the account password are incorrect, the blockchain-based carbon neutral transaction processing method goes to Step S302 mentioned above.

Step S408: The server 40 identifies whether the account 404 is valid. If the server 40 identifies that the account 404 is valid, the blockchain-based carbon neutral transaction processing method can optionally go to Step S502, Step S602 or Step S702. If the server 40 identifies that the account 404 is invalid, the blockchain-based carbon neutral transaction processing method goes to Step S302 mentioned above.

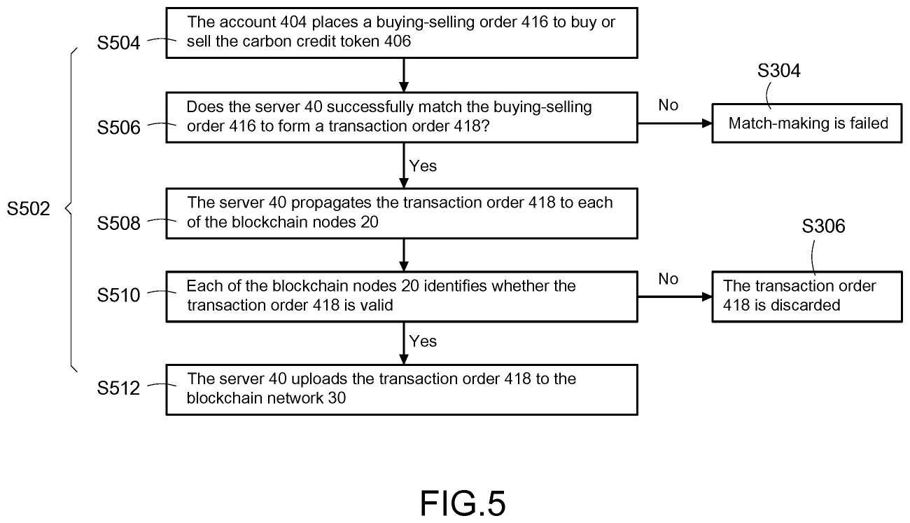

Moreover, FIG. 5 shows a flow chart of another part of the second embodiment of the blockchain-based carbon neutral transaction processing method of the present disclosure; please refer to FIG. 1 and FIG. 4 at the same time. Step S502 includes following substeps:

Substep S504: The account 404 places a buying-selling order 416 to buy or sell the carbon credit token 406. For example, the first user and the third user in FIG. 1 place the buying-selling orders 416 to buy or sell the carbon credit token 406. Then, the blockchain-based carbon neutral transaction processing method goes to Substep S506.

Substep S506: Does the server 40 successfully match the buying-selling order 416 to form a transaction order 418? If the server 40 successfully matches the buying-selling order 416 to form the transaction order 418, the blockchain-based carbon neutral transaction processing method goes to Substep S508. If the server 40 does not successfully match the buying-selling order 416, the blockchain-based carbon neutral transaction processing method goes to Substep S304.

Substep S508: The server 40 propagates the transaction order 418 to each of the blockchain nodes 20. Then, the blockchain-based carbon neutral transaction processing method goes to Sub step S510.

Substep S510: Each of the blockchain nodes 20 identifies (for example, using blockchain technology to identify) whether the transaction order 418 is valid. If each of the blockchain nodes 20 identifies that the transaction order 418 is valid, the blockchain-based carbon neutral transaction processing method goes to Substep S512. If each of the blockchain nodes 20 identifies that the transaction order 418 is invalid, the blockchain-based carbon neutral transaction processing method goes to Sub step S306.

Substep S512: The server 40 uploads the transaction order 418 to the blockchain network 30. So far, the blockchain-based carbon neutral transaction processing method is completed.

Sub step S304: Match-making is failed.

Substep S306: The transaction order 418 is discarded.

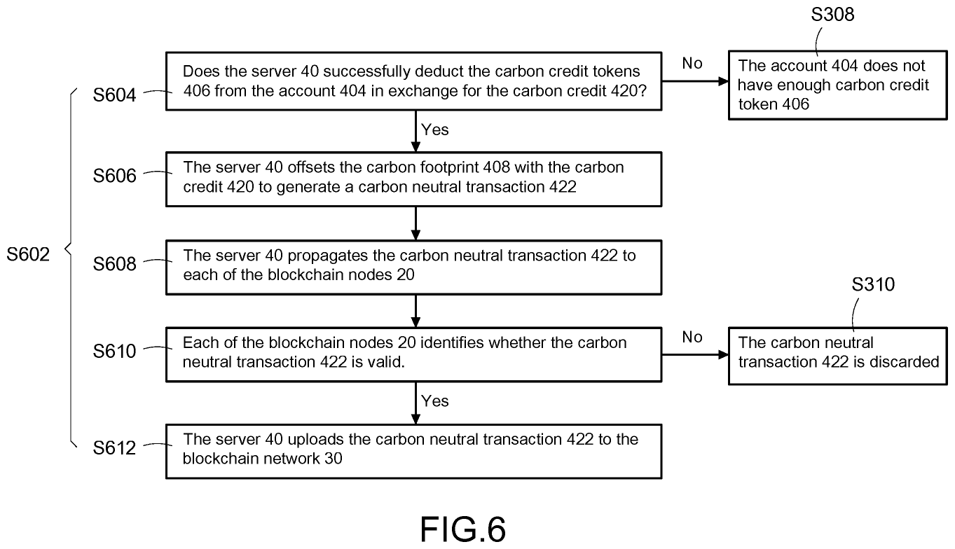

Moreover, FIG. 6 shows a flow chart of another part of the second embodiment of the blockchain-based carbon neutral transaction processing method of the present disclosure; please refer to FIG. 1 and FIG. 4 at the same time. Step S602 includes following sub steps:

Substep S604: Does the server 40 successfully deduct the carbon credit tokens 406 from the account 404 in exchange for the carbon credit 420? If the server 40 successfully deducts the carbon credit tokens 406 from the account 404 in exchange for the carbon credit 420, the blockchain-based carbon neutral transaction processing method goes to Substep S606. If the server 40 does not successfully deduct the carbon credit tokens 406 from the account 404, the blockchain-based carbon neutral transaction processing method goes to Substep S308.

Substep S606: The server 40 offsets the carbon footprint 408 with the carbon credit 420 to generate a carbon neutral transaction 422. Then, the blockchain-based carbon neutral transaction processing method goes to Sub step S608. For example, the fifth user in FIG. 1 offsets the carbon footprint 408 with the carbon credit 420 to generate the carbon neutral transaction 422.

Substep S608: The server 40 propagates the carbon neutral transaction 422 to each of the blockchain nodes 20. Then, the blockchain-based carbon neutral transaction processing method goes to Substep S610.

Substep S610: Each of the blockchain nodes 20 identifies (for example, using blockchain technology to identify) whether the carbon neutral transaction 422 is valid. If each of the blockchain nodes 20 identifies that the carbon neutral transaction 422 is valid, the blockchain-based carbon neutral transaction processing method goes to Substep S612. If each of the blockchain nodes 20 identifies that the carbon neutral transaction 422 is invalid, the blockchain-based carbon neutral transaction processing method goes to Substep S310.

Substep S612: The server 40 uploads the carbon neutral transaction 422 to the blockchain network 30. So far, the blockchain-based carbon neutral transaction processing method is completed.

Substep S308: The account 404 does not have enough carbon credit token 406.

Sub step S310: The carbon neutral transaction 422 is discarded.

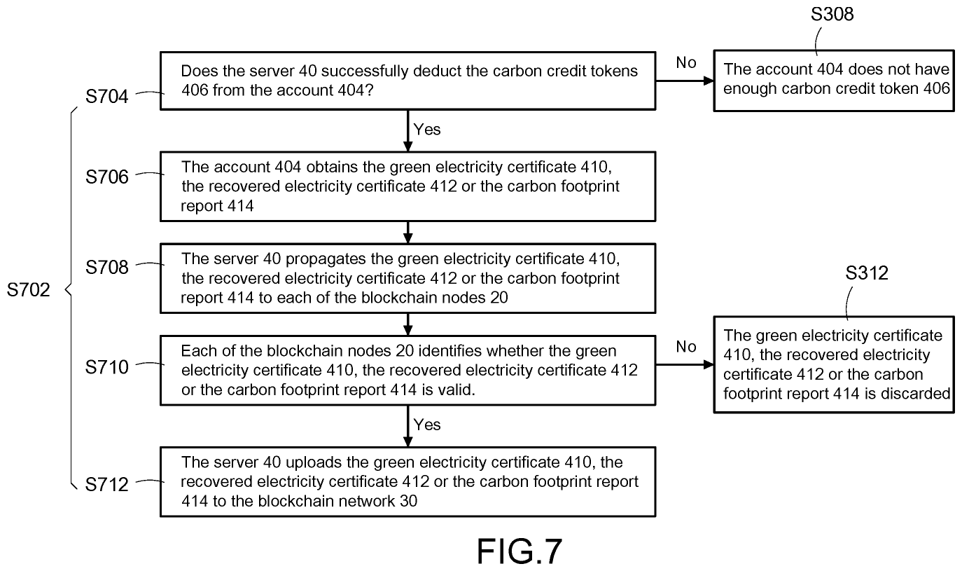

Moreover, FIG. 7 shows a flow chart of another part of the second embodiment of the blockchain-based carbon neutral transaction processing method of the present disclosure; please refer to FIG. 1 and FIG. 4 at the same time. Step S702 includes following sub steps:

Substep S704: Does the server 40 successfully deduct the carbon credit tokens 406 from the account 404? If the server 40 successfully deducts the carbon credit tokens 406 from the account 404, the blockchain-based carbon neutral transaction processing method goes to Substep S706. If the server 40 does not successfully deduct the carbon credit tokens 406 from the account 404, the blockchain-based carbon neutral transaction processing method goes to Substep S308.

Substep S706: The account 404 obtains the green electricity certificate 410, the recovered electricity certificate 412 or the carbon footprint report 414. Then, the blockchain-based carbon neutral transaction processing method goes to Substep S708. For example, the second user in FIG. 1 obtains the green electricity certificate 410; the fourth user in FIG. 1 obtains the recovered electricity certificate 412; the fifth user in FIG. 1 obtains the carbon footprint report 414.

Substep S708: The server 40 propagates the green electricity certificate 410, the recovered electricity certificate 412 or the carbon footprint report 414 to each of the blockchain nodes 20. Then, the blockchain-based carbon neutral transaction processing method goes to Substep S710.

Substep S710: Each of the blockchain nodes 20 identifies whether the green electricity certificate 410, the recovered electricity certificate 412 or the carbon footprint report 414 is valid. If each of the blockchain nodes 20 identifies that the green electricity certificate 410, the recovered electricity certificate 412 or the carbon footprint report 414 is valid, the blockchain-based carbon neutral transaction processing method goes to Substep S712. If each of the blockchain nodes 20 identifies that the green electricity certificate 410, the recovered electricity certificate 412 or the carbon footprint report 414 is invalid, the blockchain-based carbon neutral transaction processing method goes to Sub step S312.

Substep S712: The server 40 uploads the green electricity certificate 410, the recovered electricity certificate 412 or the carbon footprint report 414 to the blockchain network 30. So far, the blockchain-based carbon neutral transaction processing method is completed.

Substep S308: The account 404 does not have enough carbon credit token 406.

Substep S312: The green electricity certificate 410, the recovered electricity certificate 412 or the carbon footprint report 414 is discarded.

The processes of FIG. 4, FIG. 5, FIG. 6, and FIG. 7 mentioned above can monetize the carbon credit token 406.

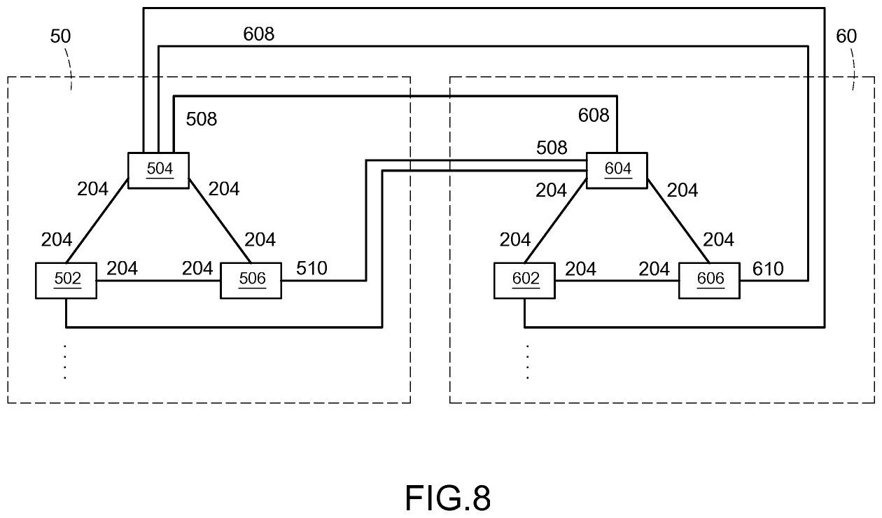

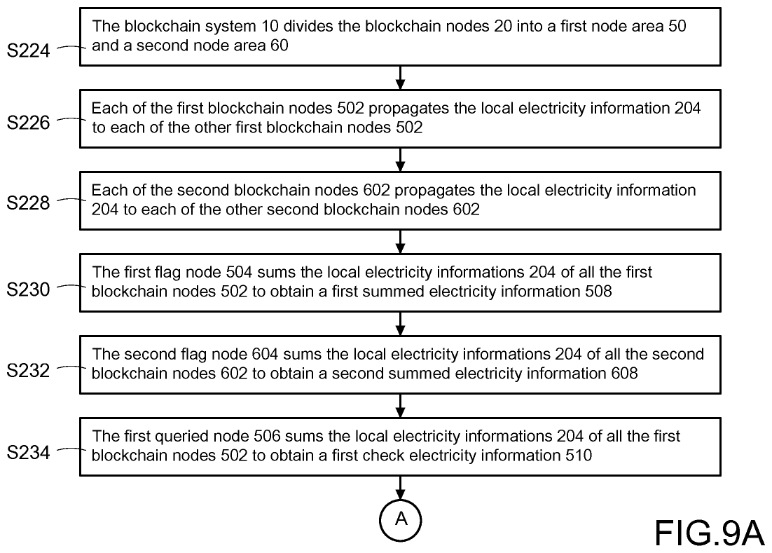

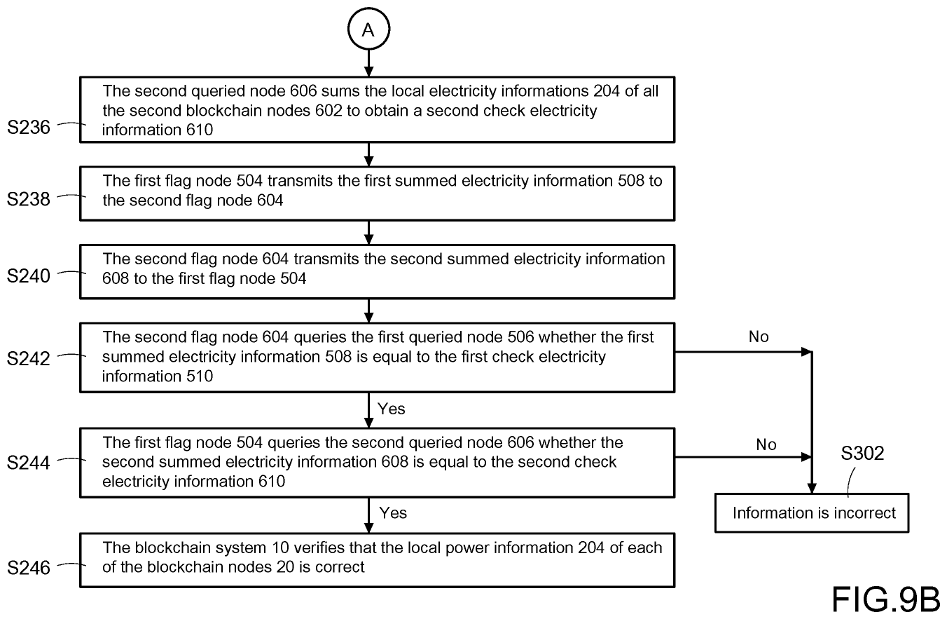

Moreover, FIG. 8 shows a block diagram of another part of the embodiment of the blockchain-based carbon neutral transaction processing system of the present disclosure. FIG. 9A and FIG. 9B show flow charts of another part of the first embodiment of the blockchain-based carbon neutral transaction processing method of the present disclosure. FIG. 8, FIG. 9A and FIG. 9B are intended to minutely explain Step S216 of FIG. 2 (namely, the blockchain system 10 verifies whether the local electricity information 204 of each of the blockchain nodes 20 is correct), which includes, for example, following substeps:

Substep S224: The blockchain system 10 divides the blockchain nodes 20 into a first node area 50 and a second node area 60; moreover, the blockchain nodes 20 within the first node area are defined as a plurality of first blockchain nodes 502; the first blockchain nodes 502 include a first flag node 504 and a first queried node 506; the blockchain nodes 20 within the second node area 60 are defined as a plurality of second blockchain nodes 602; the second blockchain nodes 602 include a second flag node 604 and a second queried node 606. Then, the blockchain-based carbon neutral transaction processing method goes to Substep S226.

Substep S226: Each of the first blockchain nodes 502 propagates the local electricity information 204 to each of the other first blockchain nodes 502. Then, the blockchain-based carbon neutral transaction processing method goes to Substep S228.

Substep S228: Each of the second blockchain nodes 602 propagates the local electricity information 204 to each of the other second blockchain nodes 602. Then, the blockchain-based carbon neutral transaction processing method goes to Substep S230.

Substep S230: The first flag node 504 sums the local electricity information 204 of all the first blockchain nodes 502 to obtain a first summed electricity information 508. Then, the blockchain-based carbon neutral transaction processing method goes to Substep S232.

Substep S232: The second flag node 604 sums the local electricity information 204 of all the second blockchain nodes 602 to obtain a second summed electricity information 608. Then, the blockchain-based carbon neutral transaction processing method goes to Substep S234.

Substep S234: The first queried node 506 sums the local electricity information 204 of all the first blockchain nodes 502 to obtain a first check electricity information 510. Then, the blockchain-based carbon neutral transaction processing method goes to Substep S236.

Substep S236: The second queried node 606 sums the local electricity information 204 of all the second blockchain nodes 602 to obtain a second check electricity information 610. Then, the blockchain-based carbon neutral transaction processing method goes to Substep S238.

Substep S238: The first flag node 504 transmits the first summed electricity information 508 to the second flag node 604. Then, the blockchain-based carbon neutral transaction processing method goes to Substep S240.

Substep S240: The second flag node 604 transmits the second summed electricity information 608 to the first flag node 504. Then, the blockchain-based carbon neutral transaction processing method goes to Substep S242.

Substep S242: The second flag node 604 queries the first queried node 506 whether the first summed electricity information 508 is equal to the first check electricity information 510. If the first summed electricity information 508 is equal to the first check electricity information 510, the blockchain-based carbon neutral transaction processing method goes to Substep S244. If the first summed electricity information 508 is not equal to the first check electricity information 510, the blockchain-based carbon neutral transaction processing method goes to Substep S302.

Sub step S244: The first flag node 504 queries the second queried node 606 whether the second summed electricity information 608 is equal to the second check electricity information 610. If the second summed electricity information 608 is equal to the second check electricity information 610, the blockchain-based carbon neutral transaction processing method goes to Sub step S246. If the second summed electricity information 608 is not equal to the second check electricity information 610, the blockchain-based carbon neutral transaction processing method goes to Sub step S302.

Sub step S246: The blockchain system 10 verifies that the local power information 204 of each of the blockchain nodes 20 is correct.

Step S302: Information is incorrect.

In conclusion, the present disclosure is used to solve the problems of verification of carbon credit data generated by current various green electricity and the problems of distributed electricity storage distribution and application.

The present disclosure includes following three features:

1. Blockchain is materialized; blockchain technology is transformed and bound with the application of AIoT entity carrier. A carbon neutral platform is achieved by the application which combines blockchain technology and the cryptocurrency.

2. Distributed green electricity storage and smart distribution (for example, the mobile electricity box).

3. Carbon credit and electricity are separate. Monetize the cryptocurrency (namely, realize).

The physical sensors are arranged on various green electricity generating apparatuses, and the data security is confirmed through two locks of software and hardware, and the process cannot be tampered with. Based on the value of one kilowatt-hour of electricity, there is a consideration relationship with the electricity price of physical material green electricity, and then the electricity price of physical material green electricity is bi-directionally verified by the amount of carbon credit established by the International Carbon Credit Association, and then the true value of carbon credit is settled. The third-party data certificate is issued not by humans but by machines.

The present disclosure can be applied in following three major directions:

1. Various green electricity generating apparatuses (which generate solar energy, hydro energy, wind energy, tidal energy, geothermal energy, hydrogen energy, and so on; namely, electricity without carbon emissions).

2. Electricity saving and carbon reduction certification achieved by the factory importing the green electricity or using the electricity saving apparatus.

3. Examination and calculation of the factory's carbon supply chain (no longer rely on manpower); the production line from upstream to downstream conforms to ISO regulations.

The advantage of the present disclosure is to make the carbon neutral transaction processing method and the carbon neutral transaction processing system simple and clear.

What is claimed is:

1. A blockchain-based carbon neutral transaction processing method comprising:
generating a local electricity information by an electricity sensor of each of a plurality of blockchain nodes of a blockchain system;
verifying whether the local electricity information of each of the blockchain nodes is correct by the blockchain system after the electricity sensor generates the local electricity information; and
uploading the local electricity information of each of the blockchain nodes to a blockchain network of the blockchain system by the blockchain system if the blockchain system verifies that the local electricity information of each of the blockchain nodes is correct.

2. The blockchain-based carbon neutral transaction processing method of claim 1, further comprising:
verifying whether the local electricity information is correct by the electricity sensor after the electricity sensor generates the local electricity information;
verifying whether the local electricity information is correct by a server of the blockchain system after the electricity sensor generates the local electricity information; and
storing the local electricity information by the blockchain node if the electricity sensor verifies that the local electricity information is correct and the server verifies that the local electricity information is correct.

3. The blockchain-based carbon neutral transaction processing method of claim 2, further comprising:
obtaining a configuration profile from the server by the blockchain node;
setting a plurality of hard-wired electrical parameters of the electricity sensor based on the configuration profile by the electricity sensor after the blockchain node obtains the configuration profile from the server;
sensing an electricity apparatus of the blockchain node by the electricity sensor after the electricity sensor sets the hard-wired electrical parameters of the electricity sensor based on the configuration profile; and
generating the local electricity information by the electricity sensor after the electricity sensor senses the electricity apparatus of the blockchain node.

4. The blockchain-based carbon neutral transaction processing method of claim 3, wherein the blockchain system verifies whether the local electricity information of each of the blockchain nodes is correct after the blockchain node stores the local electricity information.

5. The blockchain-based carbon neutral transaction processing method of claim 4, further comprising:
generating an electricity certification on the blockchain network based on the local electricity information by the blockchain system after the blockchain system uploads the local electricity information of each of the blockchain nodes to the blockchain network of the blockchain system; and
storing the electricity certification in an account of the server by the server.

6. The blockchain-based carbon neutral transaction processing method of claim 5, wherein the electricity sensor is a smart meter, the electricity apparatus is a green electricity generating apparatus, the electricity certification is a carbon credit token, and the server is a cloud artificial intelligence server.

7. The blockchain-based carbon neutral transaction processing method of claim 5, wherein the electricity sensor is a smart meter, the electricity apparatus is an electricity consuming apparatus, the electricity certification is a carbon footprint, and the server is a cloud artificial intelligence server.

8. The blockchain-based carbon neutral transaction processing method of claim 5, further comprising:
buying or selling a plurality of carbon credit tokens by a plurality of the accounts with each other;
offsetting a carbon footprint with a carbon credit by the account; and
purchasing a green electricity certificate, a recovered electricity certificate or a carbon footprint report with the carbon credit tokens by the account.

9. A blockchain-based carbon neutral transaction processing system comprising:
a plurality of blockchain nodes; and
a blockchain network electrically connected to the blockchain nodes,
wherein each of the blockchain nodes comprises:
an electricity sensor,
wherein the electricity sensor is configured to generate a local electricity information; after the electricity sensor generates the local electricity information, the blockchain-based carbon neutral transaction processing system is configured to verify whether the local electricity information of each of the blockchain nodes is correct; if the blockchain-based carbon neutral transaction processing system verifies that the local electricity information of each of the blockchain nodes is correct, the blockchain-based carbon neutral transaction processing system is configured to upload the local electricity information of each of the blockchain nodes to the blockchain network.

10. The blockchain-based carbon neutral transaction processing system of claim 9, further comprising:
a server electrically connected to the blockchain network,
wherein each of the blockchain nodes further comprises:
an electricity apparatus electrically connected to the electricity sensor,
wherein the electricity sensor is configured to sense the electricity apparatus to generate the local electricity information; after the electricity sensor generates the local electricity information, the electricity sensor is configured to verify whether the local electricity information is correct; after the electricity sensor generates the local electricity information, the server is configured to verify whether the local electricity information is correct; if the electricity sensor verifies that the local electricity information is correct and the server verifies that the local electricity information is correct, the blockchain node is configured to store the local electricity information.
